(19) United States
(12) Patent Application Publication
(10) Pub. No.: US 2011/0178363 A1
(43) Pub. Date: Jul. 21, 2011

(54) PROGRAMMABLE HEARING PROSTHESES

(76) Inventors: Koen Van Herck, Kontich (BE); Koen Van Den Heuvel, Hove (BE)

(21) Appl. No.: 13/001,621

(22) PCT Filed: Jun. 25, 2009
(86) PCT No.: PCT/AU2009/000810

§ 371 Date: Apr. 7, 2011

(30) Foreign Application Priority Data
Jun. 25, 2008 (AU) 2008903256

(51) Int. Cl. H04R 25/00; G06F 9/00

(52) U.S. Cl. 600/25; 713/100

(57) ABSTRACT

A hearing prosthesis and method of programming a processor of a hearing prosthesis are described. In order to provide compatibility with updated fitting software, the prosthesis stores at least the transformation instructions to convert measured parameters into operating coefficients for the hearing prosthesis. As a consequence, the fitting software need not be made specifically compatible with older devices.

### CROSS-REFERENCE TO RELATED APPLICATION

The present application is a National Stage application of International Patent Application No. PCT/AU2009/000810, filed Jun. 25, 2009, and claims priority from Australian Patent Application No. 2008903256, filed Jun. 25, 2008. The content of these applications is hereby incorporated by reference herein.

### BACKGROUND

1. Field of the Invention

The present invention relates generally to hearing prosthesis systems, and more particularly, to such systems which operate using clinical parameters customised to suit an individual user.

2. Related Art

It has become common for hearing prostheses to be programmed individually for each user in order to maximize both sound perception and the user's comfort. The individual programming of these devices is typically performed at a clinic by an audiologist trained to work with the relevant devices.

Such hearing prostheses include hearing aids, cochlear implants, brain stem implants, middle ear devices, bone anchored hearing aids, and in general devices providing electrical stimulation, acoustic stimulation, mechanical stimulation, or combinations thereof. The prostheses may be fully implanted, partly implanted, or fully external devices.

In order to program the prostheses, the firmware in the processor of the prosthesis is configured to function in accordance with measured patient-specific clinical parameters. For example, when customizing cochlear implants, the audiologist determines the minimum and maximum current level outputs for each electrode in the array based on the patient's reports of perceived loudness. The specific parameters required will vary with the device.

This programming is carried out by transforming the clinical parameters into firmware coefficients, which are values used by the embedded processor while running the firmware, and then writing these coefficients to the processor's memory. The firmware coefficients are represented in the native data format used by the processor, and are optimized so as to be easily used in the real-time firmware.

The transformation of one or more clinical parameters into one or more firmware coefficients is performed using a formula or an algorithm, which usually forms part of the fitting software used by the audiologist when customizing the prosthesis for a patient. Currently, it is typical for the fitting software to run on a Microsoft Windows based PC located in the clinic. The transformation algorithm is typically programmed in a language such as C++ and compiled as a library, e.g. a dynamic link library (DLL), which forms part of the fitting software.

However, the clinical parameters may well need to be revised over the life of the prosthesis. For example, as the user becomes habituated to the device, additional dynamic range may be acceptable to the user. On the other hand, as the user ages, further deterioration in their hearing may occur. Accordingly, the transformation process is required to be performed periodically over the life of the prosthesis.

Another factor is that while hearing aids previously had a lifetime of at most 15 years, as prosthesis technology becomes more advanced, a particular prosthesis may be used by a patient over his or her entire lifetime, and will therefore need to be supported during this time to remain effective. This is particularly the case for partly or totally implanted devices. Accordingly, audiologists are reliant on the fitting software of the future continuing to be able to support and perform the transformation process for superseded prosthesis systems which are still in use by some patients. This means that as computer hardware and operating systems change over time, the fitting software will need to be reworked and maintained to remain backwards compatible with older prosthesis systems.

This problem is compounded because the fitting software is usually adapted to support a wide variety of prosthesis types and is therefore required to maintain a large number of different transformation algorithms over an extended period of time in order to remain backwards compatible with each of the prosthesis systems. This requirement for the fitting software to remain backwards compatible with older generations of prostheses places a significant burden on those responsible for the maintenance of the fitting software by greatly increasing the complexity of the maintenance process. With each new generation of prostheses, the task becomes more and more complex.

It is an object of the present invention to provide an improved method and system for facilitating the revision of clinical parameters in a hearing prosthesis.

### SUMMARY

Broadly, the present invention provides a prosthesis system in which the transformation algorithm is stored within the prosthesis. As a result, the algorithm is available whenever the parameters for the prosthesis are required to be revised.

In one aspect, the present invention provides a hearing prosthesis including a processor programmed to operate in accordance with one or more coefficients derived from parameters specific to a given user, said prosthesis including memory for storing transformation instructions for programming the processor, wherein the prosthesis is adapted to communicate the transformation instructions from the prosthesis to a system for programming the processor, so that the transformation instructions can be used to derive new values of said coefficients from the parameters, and to thereby update the hearing prosthesis with new values of said coefficients.

In a second aspect, the present invention provides a method of programming a processor of a hearing prosthesis in accordance with one or more coefficients derived from parameters specific to a given user, said method including the steps of:

a) communicating transformation instructions from a memory of the prosthesis to a system for programming the processor; and

b) the system for programming the processor deriving new values for said coefficients using the transformation instructions received from the prosthesis and said parameters specific to a given user, and updating the coefficients to the new values.

In a third aspect, the present invention provides a system for programming a hearing prosthesis so as to provide one or more coefficients derived from parameters specific to a given user, wherein said system stores parameters specific to a user, receives transformation instructions from the memory of the hearing prosthesis, interprets the transformation instructions and using said transformation instructions determines a new value of said coefficients from said stored parameters specific to a given user, and programs the hearing prosthesis with the new value of the coefficients.

Advantageously, embodiments of the present invention remove the requirement for the fitting software to be specifically adapted to transform the parameters into coefficients in respect of particular hearing prostheses, as the instructions for carrying out this process are available from the hearing prosthesis itself. By storing the information on how to program the prosthesis within the prosthesis itself, embodiments of the present invention simplify the development and maintenance of the fitting software and makes it easier to support legacy hearing prostheses in future.

### BRIEF DESCRIPTION OF THE DRAWINGS

Illustrative implementations of the present invention will be described with reference to the accompanying figures, in which:

FIG. 1 is a block diagram of an illustrative digital hearing aid;

FIG. 2 is a logical diagram illustrating the transformation process according to one implementation of the present invention for converting clinical parameters to firmware coefficients; and

FIG. 3 is a flowchart illustrating the procedure for updating clinical parameters according to an implementation of the present invention.

### DETAILED DESCRIPTION

The present invention will be described with reference to a particular illustrative example, which is a device intended for use in an electro-acoustic stimulation system. However, it will be appreciated that the present invention is applicable to any kind of programmable hearing prosthesis. It may be applied to cochlear implant systems, brain stem stimulation systems, hybrid electrical/acoustic systems, middle ear devices, hearing aid systems, bone conduction hearing aids, or any other suitable hearing prostheses. It may be applied to a system with implanted components, a fully implanted system, or a fully external system. It can be applied to BTE, ITE or other external device types.

Exemplary prostheses in which the present invention may be implemented include, but are not limited to, those systems described in U.S. Pat. Nos. 4,532,930, 6,537,200, 6,565,503, 6,575,894 and 6,697,674.

It will be appreciated that the present implementation is described for illustrative purposes, and its features are not intended to be limitative of the scope of the present invention. Many variations and additions are possible within the scope of the present invention.

To aid people with a hearing loss, prosthesis devices typically receive sound with a microphone and convert the audio signal into an acoustic or electrical output. The sound signal will generally be amplified, and a variety of more advanced sound processing operations may also be carried out. The nature of these operations is dependant in part upon the device. One such operation employs noise reduction algorithms to reduce input noise. Automatic gain control may be applied to make soft sounds more audible, and/or compression may be applied to fit the incoming sounds within the acoustic or electric hearing range of the user.

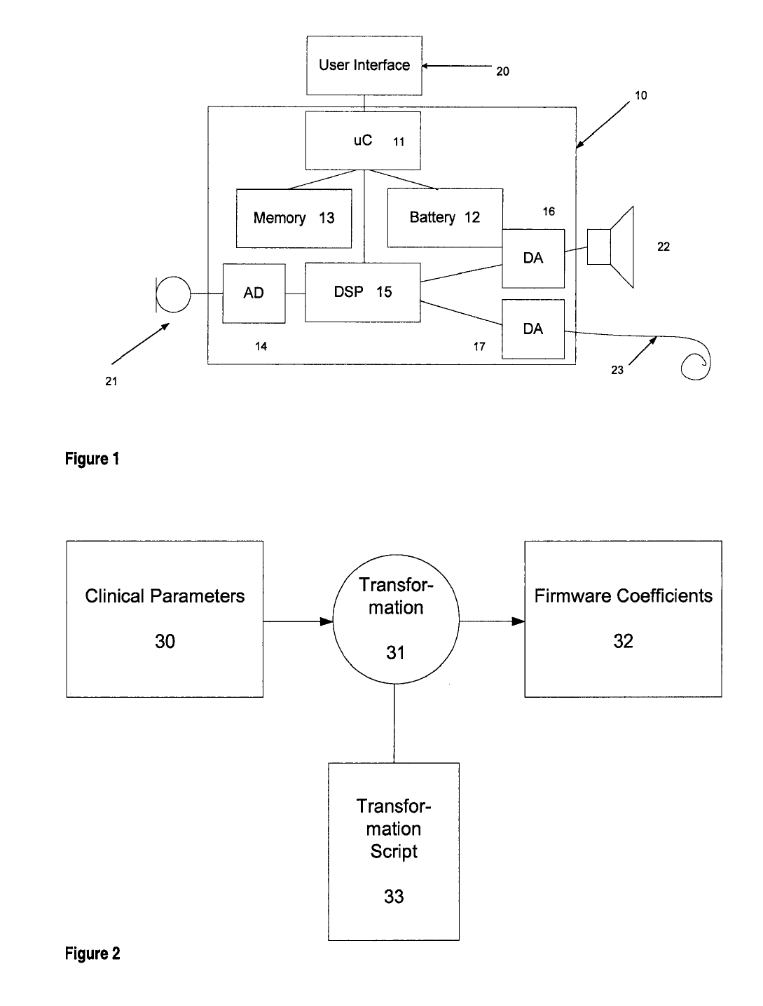

In a digital hearing device, such as the cochlear implant 10 illustrated conceptually in FIG. 1, sound is received by microphone 21 and passed to an analog-to-digital converter (ADC) 14 to convert the analog signal to a digital signal. The digital signal processor (DSP) 15 then processes the digital signal to produce appropriate stimuli. In this example, DSP 15 produces a set of stimulus instructions, which are converted to analog electrical stimuli by DA 17, to be delivered by the intra-cochlear electrode array 23. DSP 15 also produces a set of stimuli which are converted by DA 16 into analog, acoustic stimuli for the acoustic transducer 22. In the case of the electrical stimuli, the sound signal is processed in order to generate a set of electrical stimuli, the nature, timing and location of which are determined by the processor. It will be appreciated that the precise nature of this processing and mapping process does not form part of the present invention. However, the parameters associated with such electrical stimulation, including for example the comfort and threshold levels for each electrode and the channel to electrode mapping, may be managed as clinical parameters in the context of the present invention.

Cochlear implant 10 also includes a battery 12, and a memory 13, preferably non-volatile, for the storage of software, parameters, and the like. The overall operations of the implant are controlled by microprocessor 11. User interface 20 allows for the exchange of data, telemetry, control settings, and the like.

It will be appreciated that while the following discussion is in reference to a DSP of an electro-acoustic implant, the invention may be equally applied to any processor of any hearing prosthesis. For example, the invention may equally be applied to a speech processor within the behind-the-ear (BTE) portion of a cochlear implant, or to a hearing aid.

Since each person has a different hearing loss, and responds differently to stimuli, the prosthesis is required to be individually fitted to a given user, and accordingly to perform sound processing in accordance with the requirements and preferences of the user. This is well understood by those expert in the field. A person with a high level of hearing loss needs more amplification for acoustic stimulation, ie gain in dB, than a person with a lower level of hearing loss. Hearing loss may also be different at different frequencies; that is, some people may have a flat hearing loss and will require similar amplification for each frequency, but most people will have a different level of hearing loss at each frequency and will therefore require the amplification to be adjusted accordingly. Furthermore, personal preferences are different from user to user, so that while some people prefer higher levels for better sound clarity, others prefer that hearing comfort is maximized.

This patient specific information is defined as values known as clinical parameters and are usually indicated as values, such as physical units or pure numbers such as dB. Other clinical parameters are Boolean in nature and are not defined in terms of a unit.

One typical example of a prosthesis program for a certain user is illustrated in the table below:

| Clinical Parameter | Value | Unit |
|---|---|---|
| Automatic Gain Control | Off | NA |
| Noise Reduction | On | NA |
| Gain channel 1 | 35 | dB |
| MPO channel 1 | 95 | dB SPL |
| Gain channel 2 | 45 | dB |
| MPO channel 2 | 97 | dB SPL |
| Gain channel 3 | 42 | dB |
| MPO channel 3 | 96 | dB SPL |
| Volume range | 10 | dB |

The arithmetic calculations done by the DSP are optimized to use a certain amount of memory and limit the number of instructions needed to perform a certain function (e.g. the DSP may be limited to process 16 bit binary numbers). Accordingly, to perform certain types of processing, the DSP uses a program that contains arithmetic instructions which are used to convert the sound samples received by the microphone into an output signal that is sent to the DA. The program that runs in the DSP is called the firmware and requires the patient specific information in order to process the sound so as to suit the user's needs and preferences.

This patient specific information is provided to the DSP by translating the clinical parameters into coefficients that can be used by the firmware of the DSP. This process is carried out using a transformation algorithm.

The transformation algorithm is usually specific to the type of hearing prosthesis. Different types of hearing prostheses may need different transformation algorithms, since the DSP and/or the manner in which processing is performed by the DSP may be different.

Therefore, even if the clinical parameters are the same across a range of hearing aids, the translation algorithm relates to the specific DSP.

The example below illustrates the conversion of a gain parameter into a firmware readable coefficient, as well as the transformation algorithm utilised in this conversion process:

### Example of a Gain Parameter:

| Parameter | Range/Values | Description | Default value |
|---|---|---|---|
| Gain | −50 dB to +50 dB | Input gain of the | 0 dB |
| | | EAS signal in dB | |

### Resulting Coefficients:

| C_EAS_GAIN | Mantissa of the gain in the input of the EAS | |
|---|---|---|
| | signal path. | |
| | Size: | 1 entry |
| | Format: | <16, 15> signed fractional number |
| | Range: | 0 to 1 |
| | Example: | 0x7FFF = 1 |
| C_EAS_GAIN_EXP | Exponent of the gain in the input of the EAS | |
| | signal path. | |
| | Size: | 1 entry |
| | Format: | 16-bit integer |
| | Range: | −10 to +10 |
| | Example: | 0x0003 = 2\hat{ }3 |

### The Transformation Algorithm:

$$CEAS\_GAIN * {2}^{CEAS\_GAIN \_EXP} = {10}^{\frac{Gain}{20}}$$

The transformation algorithm, as illustrated in FIG. 2, includes instructions as to how the translation of the clinical parameters into firmware coefficients is to take place, and can be in the form of a scripting language program, such as Python, Ruby or Visual Basic for Applications, which can be stored in ASCII text format, or a program for virtual machine based languages, such as JAVA or C#, which can be stored in platform independent JAVA bytecode or .NET Intermediate Language.

The example below illustrates the above illustrative transformation algorithm in a scripting language, Python:

1 def transform(parameters):

2 gainDb=parameters[‘Gain’]

3 gainMantissa=10.0**(gainDb/20.0)

4 gainExponent=0

5 while gainMantissa>1:

6 gainMantissa=gainMantissa/2

7 gainExponent+=1

8 while gainMantissa<0.5:

9 gainMantissa=gainMantissa*2

10 gainExponent−=1

11 coefficients={ }

12 coefficients[‘C_GAIN’]=int(round(0×8000*gainMantissa))

13 coefficients[‘C_GAIN_EXP’]=gainExponent

14 return coefficients

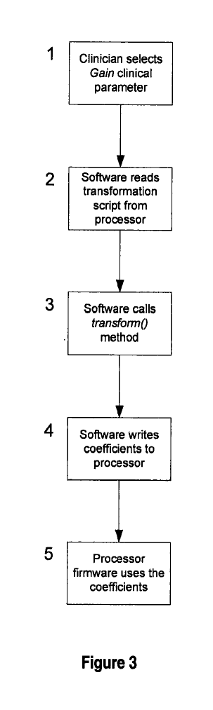

The procedure to update a clinical parameter according to this implementation is illustrated in FIG. 3.

1. The clinician selects a new Gain clinical parameter in the fitting software. This gain setting is expressed in natural units for the clinician, for example dB for a gain.

2. The software reads the transformation script from the processor's non-volatile memory. The script source is interpreted or bytecode is dynamically loaded into the software.

3. The software calls the transform method of the transformation script, the lines of which appear above. The steps of the transformation script are further described below:
a. The script gets as input a collection of clinical parameters from the software (line 1).
b. The script extracts the relevant clinical parameter from the collection of parameters (line 2).
c. It converts the parameters from the clinical units (e.g. dB) into internal units (e.g. fractional number) (line 3).
d. It executes the transformation algorithm (lines 4-10).
e. It creates a collection of coefficients (line 11).
f. It converts the coefficient into units used by the processor and stores the coefficients in the collection (lines 12-13).
g. It returns the collection of coefficients to the software (line 14).

4. The software writes the coefficients to the processor's memory.

5. The processor's firmware will use the coefficient in its sound coding algorithm.

It will be appreciated that this is only one example of how the transformation may work. In practice, the transformation may be more complex, for example:
There may be more clinical parameters and coefficients.
There may be multiple transformation scripts for different clinical parameters. The result of all transformation scripts will be merged by the software.
The transformation script may make use of more complex routines, some of which may be stored in a library in the software.

It will be appreciated that the advantage of using a scripting language is that the script is readable and can be interpreted not only by a processor, but also by software programmers, allowing the script to be easily revised in the future if required. The scripts are specifically generated by a programmer to implement the required transformation algorithms.

The prosthesis is provided with memory for storing the transformation algorithm as a script of program. In order to maximize battery life of the hearing aid, it is preferred that the memory is of a non-volatile nature so that constant power is not required to sustain it. The memory may be provided in an external part of the prosthesis such as a BTE device and/or in an implanted portion.

The prosthesis is also provided with communication means for communicating the script or program from the prosthesis to the fitting software. A prosthesis is typically coupled to the programming system via a serial connection (e.g. RS 232 over wire or wireless). Commands are sent back and forward over the connection between the PC and the prosthesis. To read the script from the prosthesis memory the command might look like this: “Read_scripts_from_memory”. The reply will be a byte stream that has all the scripts. However, it will be appreciated that any suitable communications path may be used which is able to facilitate the transfer of the script or program.

The fitting software would normally reside on a Microsoft Windows based PC or similar system which can be used to program the DSP by interpreting the script, and converting the clinical parameters to firmware coefficients. Accordingly, it will be appreciated that the fitting software essentially becomes generic, or device independent, as it is able to connect to the hearing aid and download from the hearing aid all the information it requires to program the DSP.

In an alternative embodiment, a processor in the hearing aid may itself be able to program the DSP by interpreting the script, and converting the clinical parameters to firmware coefficients. For example, in a typical cochlear implant configuration which includes an external sound processor and implanted device, the external sound processor may be adapted to carry out the transformation process and program the DSP with the instructions loaded from the implant memory, or visa versa. Similarly, a first processor in the implanted portion of a cochlear implant may be adapted to carry out the transformation process and program a second processor with the instructions loaded from the implant memory.

In some embodiments, the memory of the hearing aid may also be used to store and provide access to other information which is relevant to the programming process such as the clinical parameters, specific memory locations for the coefficients, or other meta data such as special voltage levels needed to perform certain actions. In certain cases, such information may even be expanded to include complete prosthesis manuals, and/or design documentation of the prosthesis device. This information can be stored in any suitable file format, for example plain text, html or Adobe Acrobat PDF.

It will be appreciated that there are many possible implementations of the present invention, and that variations and additions are possible within the general inventive concept. Many structural and functional equivalents are available, as will be apparent to those skilled in the art.

1. A hearing prosthesis comprising:
a processor programmed to operate in accordance with one or more coefficients:
a memory for storing transformation instructions for programming the processor;
wherein the prosthesis is adapted to communicate the transformation instructions from the prosthesis to a system for programming the processor; and
wherein the transformation instructions are in accordance with a human readable scripting language and are configured to derive new values of said coefficients from parameters specific to a given user to thereby update the hearing prosthesis with said new values of said coefficients.

2. The prosthesis according to claim 1, wherein the memory is provided in an external part of the prosthesis and/or an implanted part of the prosthesis.

3. The prosthesis according to claim 1, wherein the system for programming the processor is a part of the hearing prosthesis.

4. The prosthesis according to claim 1, wherein the system for programming the processor is an external system.

5. The prosthesis according to claim 3, wherein the system for programming the processor is an external or internal part of the prosthesis and the processor is located in the other of the external or internal part of the hearing aid.

6. The prosthesis according to claim 1, wherein the memory is adapted to store further information including one or more of: parameters specific to the given user; memory locations relevant to the coefficients; meta data; manuals and design documentation.

7. The prosthesis according to claim 1, wherein the parameters specific to a user are selected from one or more of the following, either for one or more specific channels or overall: gain, maximum power levels, minimum power levels, features on or off.

8. A method of programming a processor of a hearing prosthesis in accordance with one or more coefficients said method comprising:
communicating transformation instructions from a memory of the prosthesis to a system for programming the processor, wherein the transformation instructions are in accordance with a human readable scripting language; and
the system for programming the processor deriving new values for said coefficients using the transformation instructions received from the prosthesis and said parameters specific to a given user, and updating the coefficients to the new values.

9. The method according to claim 8, wherein the processor is programmed by a part of the hearing prosthesis.

10. The method according to claim 9, wherein the processor is located in an external or internal part of the hearing aid, and the processor is programmed by the other of the external or internal part of the hearing aid.

11. The method according to claim 8, wherein the system for programming the processor is external to the prosthesis.

12. The method according to claim 8, wherein the memory means stores further information including one or more of: parameters specific to the given user; memory locations relevant to the coefficients; meta data; manuals and design documentation.

13. The method according to claim 8, wherein the parameters specific to a user are selected from one or more of the following, either for one or more specific channels or overall: gain, maximum power levels, minimum power levels, and features on or off.

14. A system for programming a hearing prosthesis so as to provide one or more coefficients derived from parameters specific to a given user, wherein said system stores parameters specific to a user, and is configured to receives transformation instructions from the memory of the hearing prosthesis, interprets the transformation instructions, use said transformation instructions to determine a new value for each of said coefficients from said stored parameters specific to a given user, and program the hearing prosthesis with the new value of the coefficients,
wherein the transformation instructions are in accordance with a human readable scripting language.

15. The system according to claim 14, wherein the system is a part of the hearing prosthesis.

16. The system according to claim 14 wherein the system is an external or internal part of the prosthesis and the processor is located in the other of the external or internal part of the hearing aid.

17. The system according to claim 14, wherein the system is external to the prosthesis.

18. The hearing prosthesis of claim 1, wherein the scripting language is selected from the set of Python, Ruby, Visual Basic for Applications, JAVA, and C#.

19. The hearing prosthesis of claim 1, wherein the transformation instructions are in ASCII text format.

20. The hearing prosthesis of claim 1, wherein the transformation instructions comprise a plurality of scripts each configured to derive new values for a subset of coefficients of said one or more coefficients.
